(19) United States
(12) Patent Application Publication
(10) Pub. No.: US 2014/0047866 A1
(43) Pub. Date: Feb. 20, 2014

(54) SYSTEM AND METHOD FOR EXHIBITING GRANULAR MATERIAL IN AN ORNAMENTAL ASSEMBLY

(71) Applicant: MARK VAUGHAN, Rio Vista, CA (US)

(72) Inventor: MARK VAUGHAN, Rio Vista, CA (US)

(21) Appl. No.: 13/589,140

(22) Filed: Aug. 19, 2012

(51) Int. Cl. A44C 7/00; B23P 11/00; A44C 5/00

(52) U.S. Cl. 63/12; 63/3.1; 29/428; 428/13

(57) ABSTRACT

A system and method for exhibiting granular material in an ornamental assembly. The sand represents a tangible embodiment of memories and emotional ties to a specific region. A transparent, flexible inner chamber holds the sand, and joins at two ends via a mating portion and a fastener. A similarly transparent, flexible outer portion encloses and contours to the shape of the inner chamber.

### BACKGROUND OF THE INVENTION

The present invention relates generally to ornamental assemblies and more specifically to ornamental assemblies that exhibit granular materials.

Ornamental assemblies, such as jewelry, are a form of personal adornment. Jewelry can include bracelets, brooches, rings, necklaces, and earrings. Jewelry normally differs from other items of personal adornment in that it has no other purpose than to look appealing. Jewelry is often associated with emotional events such as weddings, anniversaries, and storing and displaying wealth.

There are myriad styles, sizes, and brands of jewelry. Sometimes, jewelry can be fabricated to include hidden chambers or visible vessels for storing items. Various sections of the jewelry can be utilized for this function. A brooch can include a hinged front ornament that covers a cavity. Similarly, a watch can include a detachable face.

There is a human propensity to save and view tangible items that trigger memories and emotions from the past. These items are most effective in recalling the desired memories and emotions when they are accessible and viewable.

It is within the above context that a need for the present invention has arisen. There is a need to address one or more of the foregoing disadvantages of conventional systems and methods, and the present invention meets this need.

### BRIEF SUMMARY OF THE INVENTION

Various aspects of systems and methods for exhibiting granular material in an ornamental assembly can be found in exemplary embodiments of the present invention.

In a first embodiment, the ornamental assembly contains a visible predetermined quantity of indigenous granular material. Such indigenous granular material might be soil that triggers various emotions. For example, the granular material might be soil from the hometown of recently deployed military personnel, whereby the soil triggers reminders about home to encourage patriotism and provide motivation when such military personnel are away from home.

In one embodiment of the present invention, the ornamental assembly includes an inner chamber configured to receive and contain the granular material. The inner chamber is at least partially transparent so that the granular material inside the inner chamber is visible. The inner chamber includes a first end and a second end that are configured to form a loop. A mating portion joins the first end with the second end. A fastener secures the connection between the first end and the second end such that the granular material remains securely positioned inside the inner chamber.

In some embodiments, the ornamental assembly further includes an outer portion. The outer portion is configured to enclose the inner chamber. The outer portion is sufficiently flexible to contour the looped shape of the inner chamber. The outer portion is at least partially transparent so that the granular material inside the inner chamber is visible.

In other embodiments, the method includes receiving a predetermined quantity of granular material. Next, the granular material is verified, or certified to verify that it is indigenous to a desired area. The inner chamber is oriented in a position that is efficacious for receiving the granular material. The granular material is next placed into the inner chamber. Finally, the inner chamber is secured with the fastener, and the ornamental assembly may be adorned or displayed with the granular material visible.

A further understanding of the nature and advantages of the present invention herein may be realized by reference to the remaining portions of the specifications and the attached drawings. Further features and advantages of the present invention as well as the structure and operation of various embodiments of the present invention are described in detail below with respect to the accompanying drawings. In the drawings, the same reference numbers indicate identical or functionally similar elements.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a plurality of systems for exhibiting granular material in an ornamental assembly according to an exemplary embodiment of the present invention;

FIG. 2 illustrates an ornamental assembly according to an exemplary embodiment of the present invention;

FIG. 3 illustrates a fastener according to an exemplary embodiment of the present invention;

FIG. 4 illustrates a flowchart for exhibiting granular material in an ornamental assembly according to an exemplary embodiment of the present invention; and

FIG. 5 illustrates an ornamental assembly according to an exemplary embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail so as to not unnecessarily obscure aspects of the present invention.

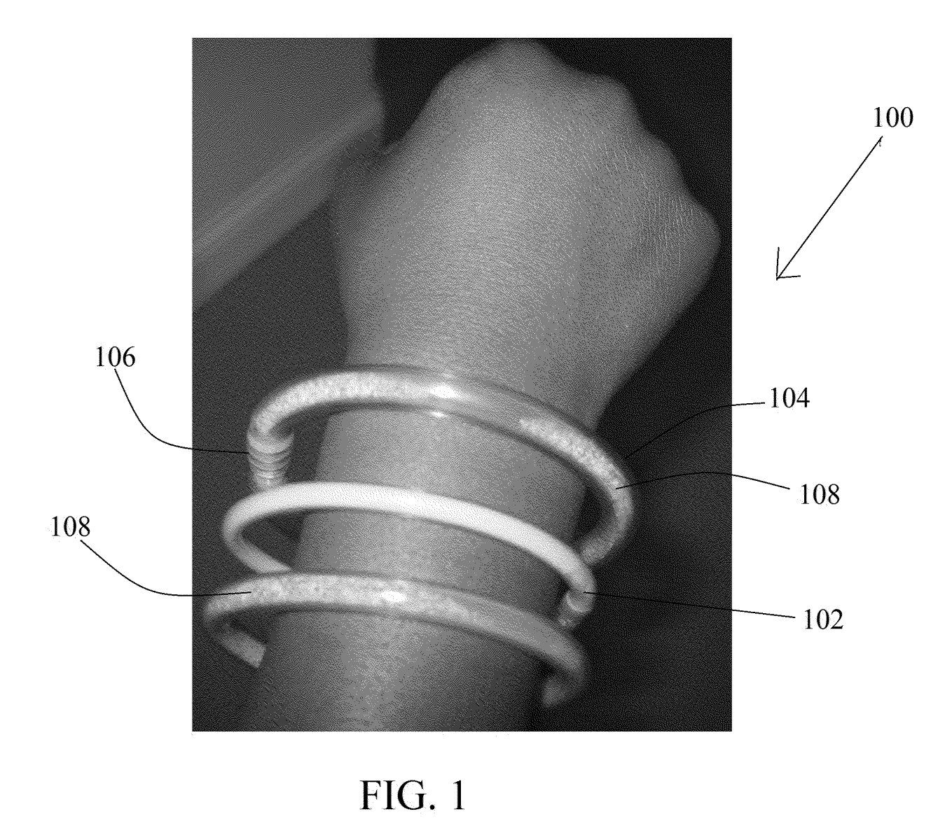

FIG. 1 illustrates ornamental assembly system 100 according to an exemplary embodiment of the present invention.

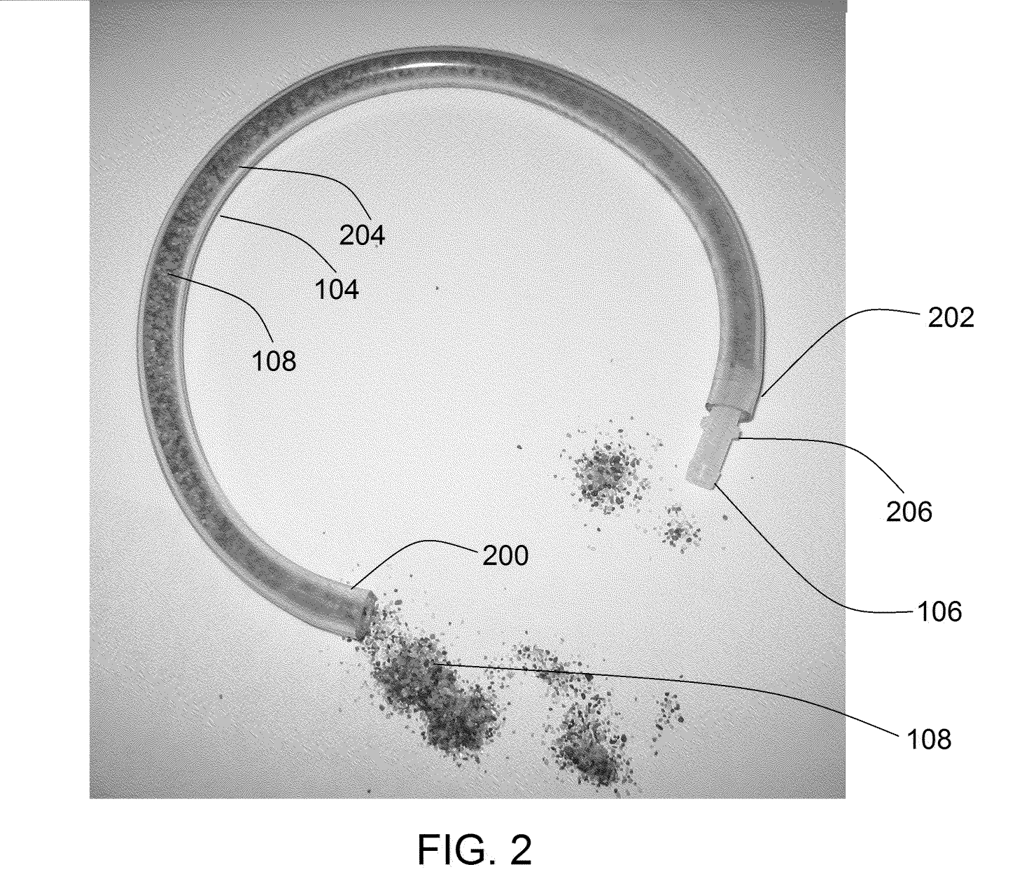

In FIG. 1, ornamental assembly system 100 can exhibit a predetermined quantity of granular material 108 that is contained inside an ornamental assembly 102. Ornamental assembly 102 is an article of jewelry or other fashion device adorned on a body. Ornamental assembly 102 includes an inner chamber 204 (FIG. 2). Inner chamber 204 includes a length of flexible transparent tubing which is loaded with a flowable granular material such as indigenous sand. However, in other embodiments, beads, mud, plants, insects, hair, etc., can also be positioned inside inner chamber 204.

Those skilled in the art, in light of the present teachings, will recognize that the indigenous sand can represent a tangible embodiment of memories and emotional ties to a specific region. By adorning ornamental assembly 102 with viewable and accessible granular material 108 inside, the respective memories and emotions become tangible by their visibility and proximity. An example includes a soldier carrying sand from a battlefield, a sports fan saving dirt or grass from a sports field, a person who migrates carrying soil from the home region to remember the people, places, and events experienced while living there, etc.

FIG. 2 illustrates ornamental assembly 102 of FIG. 1 with first end 200 and second end 202 detached from each other as well as granular material 108 according to an embodiment of the present invention.

In FIG. 2, the nature of granular material 108 is preferably varied, as by color, compactness, and porosity. Granular material 108 positions along the length of inner chamber 204 to provide a pleasing design or appearance which can be viewed through inner chamber 204. Inner chamber 204 provides airtight, waterproof containment for granular material 108. Suitable materials for inner chamber 204 include, without limitation, plastic, silicone, polyvinyl chloride, etc. A funnel can be used to facilitate loading granular material 108 into inner chamber 204.

In one alternative embodiment, inner chamber 204 comprises at least one divider. Each divider can segment inner chamber 204 to form a multiplicity of distinct and separated chambers within inner chamber 204. In this manner, various types, colors, and sizes of granular material 108 can be displayed in ornamental assembly 102. A multiplicity of apertures can position on the surface of inner chamber 204 with respect to each segmented chamber for receiving granular material 108.

An outer portion 104 contours the shape of inner chamber 204 sufficiently to enclose inner chamber 204. Outer portion 104 is sufficiently flexible to follow the looped shape, or any other shape that inner chamber 204 follows. Suitable materials for outer portion 104 include, without limitation, plastic, silicone, polyvinyl chloride, etc. Outer portion 104 is at least partially transparent so that granular material 108 inside inner chamber 204 is visible.

In one alternative embodiment, outer portion 104 may include segmented areas along a longitudinal axis that are not transparent, but rather are coated with a decorative member, including, without limitation, gold, paint, stones, etc. In this manner, granular material 108 is visible through only the transparent sections of outer portion 104. In yet another alternative embodiment, ornamental assembly 102 may not include an inner chamber 204. Rather, outer portion 104 receives and holds granular material 108, and secures from each end. In this embodiment, granular material 108 is still visible through the transparent surface of outer portion 104.

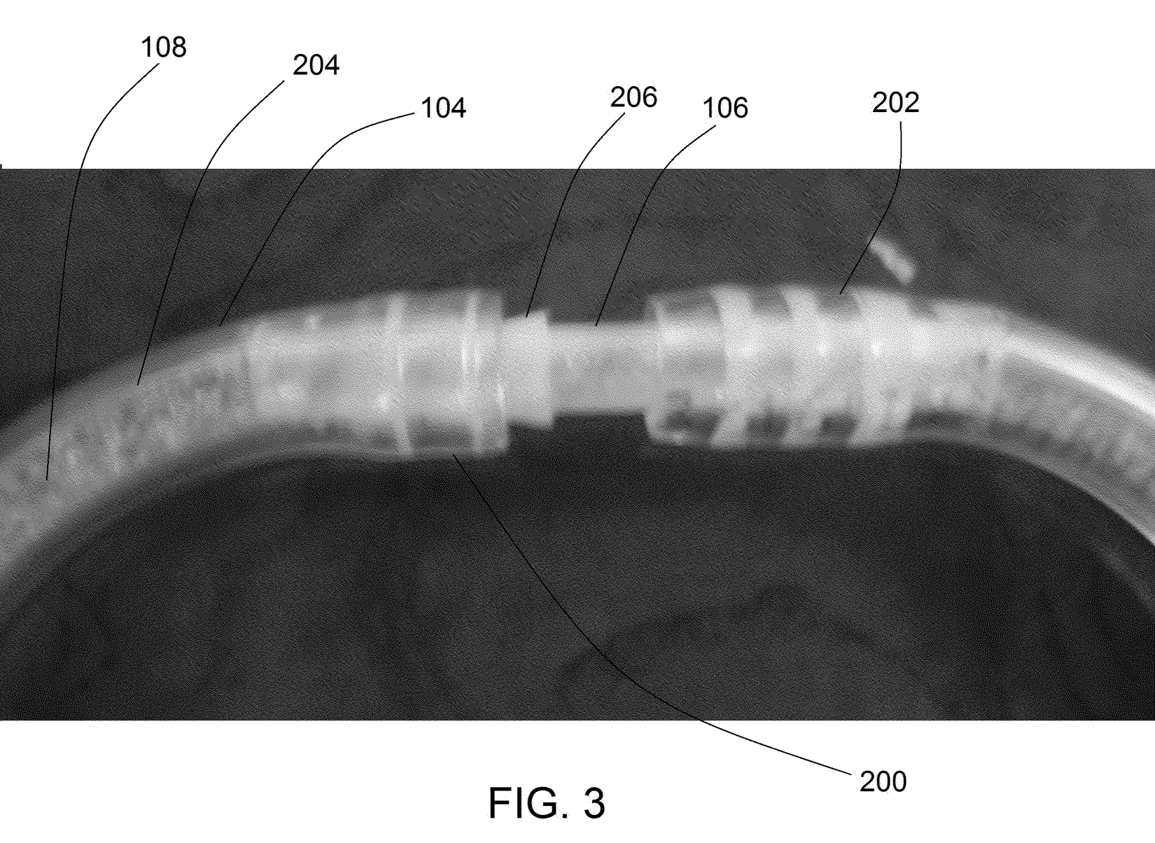

FIG. 3 illustrates mating portion 106 and fastener 206 according to an embodiment of the present invention.

In FIG. 3, mating portion 106 joins first end 200 and second end 202 of inner chamber 204 to form bracelets, necklaces and the like. In one embodiment, mating portion 106 joins first end 200 and second end 202 to form a loop. However, in other embodiments, other shapes may be formed, including, without limitation, a triangle, an oval, etc.

The diameter and general shape of the loop can be varied to accommodate different areas and sizes of a wrist or neck. In one alternative embodiment, inner chamber 204 includes a linear shape that hangs by a chain from first end 200, whereby first end 200 and second end 202 do not join. To provide a secure loop, outer portion 104 also encloses mating portion 106 to provide an exterior closed loop around inner chamber 204.

Mating portion 106 includes a fastener 206 that secures the connection between first end 200 and second end 202 such that granular material 108 remains securely positioned inside inner chamber 204. Fastener 206 can also serve as a plug to prevent granular material 108 from exiting from either first end 200 or second end 202. Fastener 206 includes an outwardly flared portion, which is configured to grip an inside surface of each end 200, 202. However, in other embodiments, mating portion 106 secures each end 200, 202 together with various fasteners 206, including, without limitation, threaded fasteners, nuts, magnets, clips, etc.

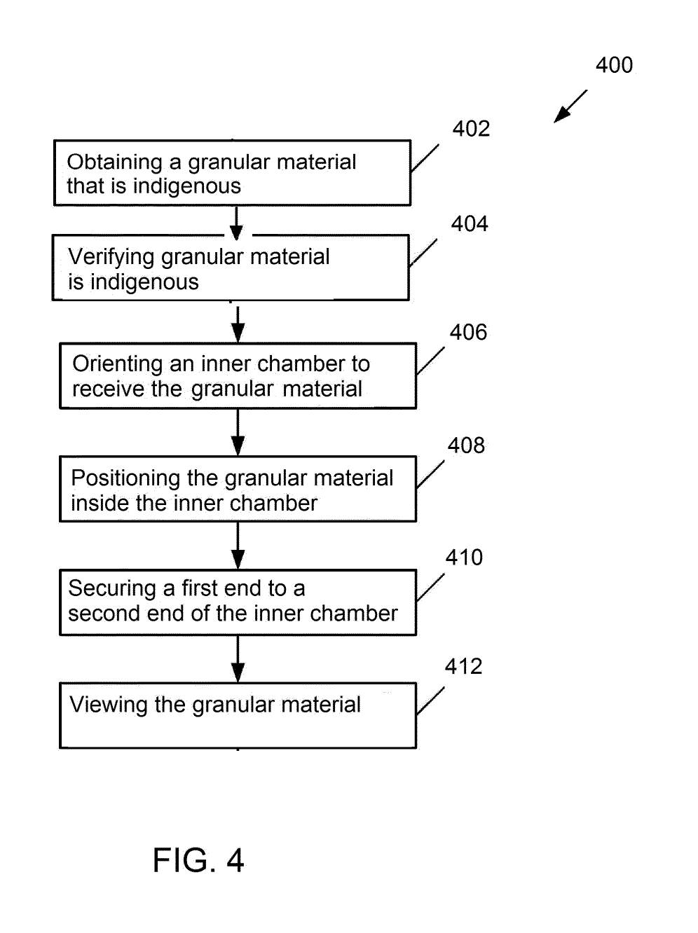

FIG. 4 illustrates a flowchart detailing an exemplary method for exhibiting granular material in an ornamental assembly 400 according to an embodiment of the present invention.

In FIG. 4, a Step 402 includes obtaining granular material 108 that is indigenous to a region and incites memories and emotions to a region. Granular material 108 includes a flowable material, such as sand, that has emotional ties to the region.

A Step 404 includes verifying granular material 108 is indigenous. Granular material 108 can include sand or soil that represents memories and emotional ties to a specific region. Granular material 108 is personal and recognizable to the adorner of ornamental assembly 102.

However, in one commercial embodiment, a certification can accompany ornamental assembly 102 to verify and certify the origin of granular material 108. By adorning ornamental assembly 102 with an indigenous granular material 108 inside, memories and emotions of the region become tangible by their visibility and proximity.

A Step 406 includes orienting inner chamber 204 to receive granular material 108. Either first end 200 or second end 202 can receive granular material 108. In one embodiment, first end 200 orients above second end 202 such that gravity forces granular material 108 into inner chamber 204.

A Step 408 includes positioning granular material 108 inside inner chamber 204. A funnel can be used to facilitate loading granular material 108 into inner chamber 204. Fastener 206 on second end 202 serves as a plug to prevent granular material 108 from exiting.

A Step 410 includes securing first end 200 to second end 202 with mating portion 106 and fastener 206. Fastener 206 secures the connection between first end 200 and second end 202 such that granular material 108 remains securely positioned inside inner chamber 204. Fastener 206 includes an outwardly flared portion, which is configured to grip an inside surface of each end 200, 202. Outer portion 104, which encloses inner chamber 204, conforms to the final shape of inner chamber 204.

A Step 412 includes viewing granular material 108 through inner chamber 204 and outer portion 104. Both inner chamber 204 and outer portion 104 are substantially transparent to allow facilitated viewing of granular material 108.

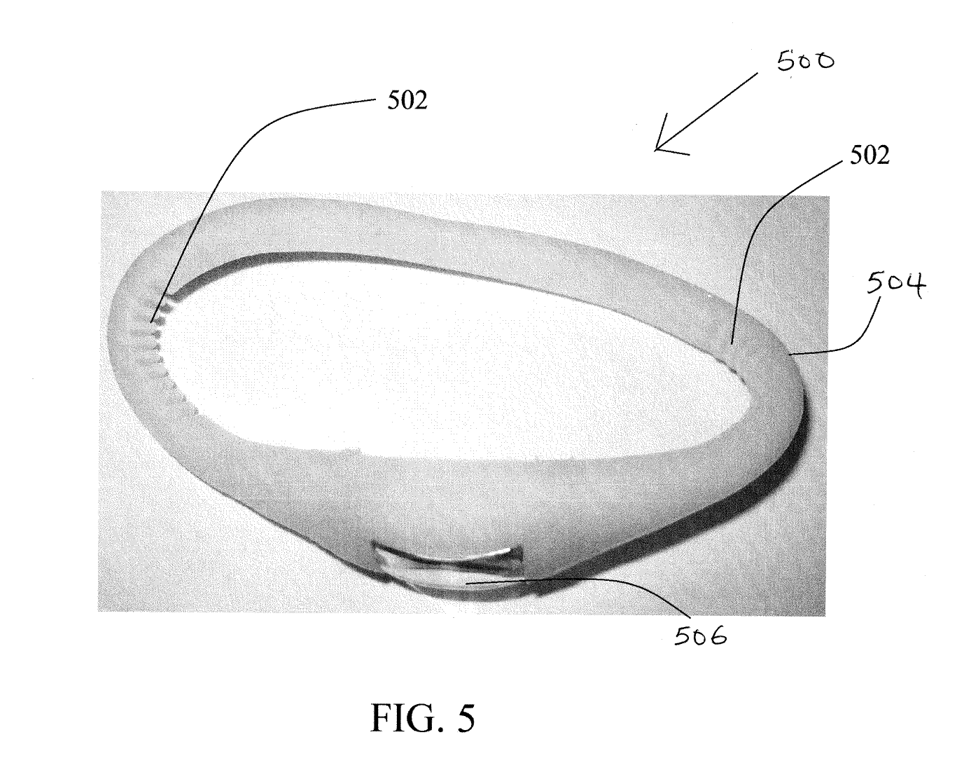

FIG. 5 illustrates ornamental assembly 500 according to an exemplary embodiment of the present invention.

In FIG. 5, ornamental assembly 500 includes transparent portion 506, grip portion 502 and outer portion 104. Outer portion 104 includes an opaque surface having various colors and textures for identification or decorative effects. An aperture (not shown) positions below transparent portion 506 and outer portion 104 to receive granular material 108 that can be viewed via transparent portion 506. In one embodiment, the aperture is detachable; upon detachment the aperture is fill-able with granular material and can then be repositioned below transparent portion 506.

In one embodiment, at least one grip portion 502 positions on an inner perimeter of outer portion 104. Grip portion 502 and/or outer portion 204 might be made of flexible polymeric or other like materials. Each grip portion 502 includes a multiplicity of parallel recesses for helping to grip a surface, such as a wrist.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A system for exhibiting a predetermined quantity of granular material in an ornamental assembly, the system comprising:
an ornamental assembly, the ornamental assembly being configured to at least partially exhibit a predetermined quantity of granular material, the ornamental assembly comprising an inner chamber, the inner chamber being configured to contain the predetermined quantity of granular material, the inner chamber comprising a first end, the inner chamber further comprising a second end, the inner chamber further comprising a mating portion, the mating portion being operable to join the first end with the second end, the mating portion comprising a fastener, the fastener being operable to secure the first end to the second end,
the ornamental assembly further comprising an outer portion, the outer portion being configured to enclose the inner chamber, the outer portion further being configured to at least partially exhibit the predetermined quantity of granular material contained inside the inner chamber.

2. The system of claim 1 wherein the predetermined quantity of granular material comprises indigenous soil.

3. The system of claim 1 wherein the predetermined quantity of granular material comprises indigenous soil and organic material.

4. The system of claim 1 wherein the predetermined quantity of granular material comprises indigenous soil and insects.

5. The system of claim 1 wherein the ornamental assembly comprises a bracelet.

6. The system of claim 1 wherein the inner chamber is configured to be at least partially transparent.

7. The system of claim 1 wherein the inner chamber is operable to be flexible.

8. The system of claim 1 wherein the inner chamber is configured to be waterproof.

9. The system of claim 1 wherein the inner chamber comprises at least one divider, at least one divider being disposed to position within the inner chamber so as to form a multiplicity of distinct and separated chambers within the inner chamber.

10. The system of claim 1 wherein the first end and the second end join to form a loop.

11. The system of claim 1 wherein the fastener comprises an outwardly flared portion, the outwardly flared portion being configured to grip an inside surface of the first end and/or the second end.

12. The system of claim 1 wherein the outer portion is at least partially transparent.

13. The system of claim 1 wherein the outer portion is configured to conform to the shape of the inner chamber.

14. The system of claim 1 wherein the outer portion is configured to enclose the mating portion.

15. A system for exhibiting a predetermined quantity of granular material in an ornamental assembly having a clip, the system comprising:
an ornamental assembly, the ornamental assembly being configured to at least partially exhibit a predetermined quantity of granular material, the ornamental assembly comprising an inner chamber, the inner chamber comprising a first end, the inner chamber further comprising a second end, the inner chamber further comprising a mating portion, the mating portion being operable to join the first end with the second end into a closed loop, the mating portion comprising a fastener for securing the first end to the second end, the mating portion further comprising a clip, the clip being configured to be operable to attach with an earlobe, wherein the predetermined quantity of granular material is contained inside the inner chamber,
the ornamental assembly further comprising an outer portion, the outer portion being configured to enclose the inner chamber, the outer portion further being configured to at least partially exhibit the predetermined quantity of granular material contained inside the inner chamber.

16. A method for exhibiting a predetermined quantity of granular material in an ornamental assembly, the method comprising:
obtaining a predetermined quantity of granular material that is indigenous;
orienting an inner chamber to receive the predetermined quantity of granular material;
positioning the predetermined quantity of granular material inside the inner chamber;
securing a first end to a second end of the inner chamber; and
viewing the predetermined quantity of granular material through the inner chamber and an outer portion.
